(19) United States
(12) Patent Application Publication
(10) Pub. No.: US 2008/0205376 A1
(43) Pub. Date: Aug. 28, 2008

(54) Redundant router having load sharing functionality

(76) Inventors: Michael Patmon, Roseville, CA (US); Shaun K. Wakumoto, Roseville, CA (US); Mark A. Tassinari, Loomis, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/712,051

(22) Filed: Feb. 28, 2007

(51) Int. Cl. H04L 12/28

(52) U.S. Cl. 370/351; 370/217; 370/221

(57) ABSTRACT

Methods, systems, and devices are provided for load sharing among network devices. One embodiment includes a network device having router functionality, including a processor, memory in communication with the processor, and executable instructions stored in memory and executable on the processor to provide router functionality redundancy for another network device having router functionality, and provide a load sharing functionality between the network devices when both devices are operational.

### BACKGROUND

In a network environment, routers can be used to transfer data packets from one network, such as a Local Area Network (LAN) or a Wide Area Network (WAN) to another. Routers are also used to disburse traffic within workgroups or network devices within a network. This can be accomplished by allocating a limited number of network devices to each router rather than sending all traffic on the network through one router.

Additionally, routers can provide filtering of inter or intra network traffic for security purposes and policy management. Router functionality can also be incorporated into other devices within a network environment, such as a switch, a bridge, a hub, and/or a file server and, therefore, the functionality within these devices can also be viewed as a router. Such devices providing routing functionality are referred to herein as “network devices having router functionality”.

Routers can be connected between a number of network clients and various network devices, such as those mentioned above. In some situations, these one or more routers can go offline, become overloaded, or malfunction.

For example, during a power outage, the router may lose power and the network connection is lost. Additionally, a router can become overloaded with information and can shut itself down or limit the amount of information it can receive to protect itself. If the device does not take such actions, in some instances, the device can be overwhelmed by the information such that the router becomes “frozen” and can no longer process information effectively.

In some such cases, the packets of information in transit through the router can be lost. In such systems, in order to save the packets of information in transit, router redundancy protocols (RRPs), such as XRRP (XL RRP created by Hewlett Packard) or VRRP (Virtual RRP created by the Internet Engineering Task Force (IETF)) have been developed to allow a number of routers to be configured such that a router can provide a back up for another router.

Router redundancy protocols provide redundant router functionality in situations in which, if a router fails, another router can take over the routing function of the failed router. In this way, the loss of data, from a data stream passing through a router that fails, can be reduced and an increase in the continuity of the connection with the routers can be provided.

Routers that are used to backup other routers can include a router interface provided thereon. The redundant router interface provides a router functionality that can be used if the other router in the pair fails. In this disclosure, although pairs of routers are discussed as an example of a type of redundancy, the embodiments are not limited to pairs of redundant devices and some embodiments can utilize more than two redundant devices backing each other up.

Router redundancy protocols are configured on an Internet protocol (IP) interface basis. If two routers are configured as a RRP pair, both routers have an IP interface configured on the same IP network and one router's IP interface is active while the other's is in standby. In some systems, a pair of routers can be configured together in an RRP fashion on multiple interfaces.

The use of these redundant devices to step in when a routing device becomes inoperable has been helpful in reducing downtime of the system. However, such redundant systems can be expensive due to the use of a redundant device that does not provide routing when the primary device is operational.

### BRIEF DESCRIPTION OF THE DRAWINGS

FIG. 1 illustrates a system embodiment having a communication network utilizing multiple redundant routers.

FIG. 2 illustrates an example of a router redundancy configuration embodiment where the routers are communicating with several computing devices on the network.

FIG. 3 illustrates a network device embodiment having router redundancy functionality.

### DETAILED DESCRIPTION

Various methods, devices, and systems for providing router redundancy and load sharing by a number of network devices having routing capability are described below. For example, in various embodiments, a network device having router functionality can include a logic circuitry, memory in communication with the logic circuitry, and executable instructions stored in memory and executable on the logic circuitry. The executable instructions can be used to provide router functionality redundancy for another network device having router functionality and provide a load sharing functionality between the network devices when both devices are operational, among other functions.

As stated above, routing functionality can be provided on a variety of network devices. For example, one or more network devices with routing functionality can be management stations, network switches, network hubs, and/or other suitable devices connected to the network.

In order for the other network devices to know where to send communications, each of the network devices has to have a network address. Such devices usually include a media access control address (e.g., MAC address) and an Internet protocol address (i.e., IP address).

In some embodiments, the redundant network devices can have the same Internet protocol address as their paired counterpart (or more counterparts, if more than two redundant devices are associated to provide redundancy). This can enable traffic to be routed to the same Internet protocol address regardless of whether a first, a second, or other network device is providing the routing functionality.

In various embodiments, the network devices with a common Internet protocol address can have different media access control addresses. In this way, the information can be forwarded to a particular network device via the MAC address. This can be beneficial with devices having the same IP address since the information can be routed to a particular network device within the devices associated with a particular Internet protocol address.

Various network devices can include executable instructions which execute to utilize the same Internet protocol address for a first network device as that of one or more other network devices having router functionality. Devices can also include executable instructions which execute to utilize a different media access control address for the network device than that of one or more other network devices having router functionality.

Also included are a number of system embodiments. For example, in various embodiments, the network management system can include a first router and a second router including a logic circuit, memory in communication with the logic circuit, and instructions stored in memory and executable on the logic circuit.

Such instructions can include instructions to provide redundancy of a router functionality of the first router, and a mechanism for sharing (e.g., balancing) a load of packets to be routed across multiple routers including at least the first router and the second router. In this way, the redundant router can provide load sharing for the primary router, thereby reducing packet traffic on the primary router. The mechanism can be provided by executable instructions and/or logic circuitry such as a processor or application specific integrated circuit among other types of logic circuitry suitable for executing such instructions.

The load sharing functionality of a system having multiple routers can, for example, utilize a hash function, among other suitable mechanisms for load sharing between two or more routers. In some embodiments, a hash function (e.g., a modulo hash function) can be executed on at least two routers and one winner can be determined.

The winner can be determined, for example, based upon the remainder of the hash function. For instance, a hash function can be used to operate on the contents of a packet (e.g., a MAC address or a portion thereof, for instance, received as part of an ARP request).

In embodiments using a modulo hash function, each router can be assigned a number (e.g., for a two router redundant pair, the routers can be numbered 0 and 1). The modulo hash function provides a result that is a remainder.

A winner can then, for example, be selected as the router to receive the packet to be routed. Such selection can, for instance, be accomplished by sending an address resolution protocol (ARP) response to a computing device from the selected router once the selection has been made.

The winner can be determined for example, by using the assigned router number and the result of the hash function. For instance, if the divisor used is the number of routers (e.g., 2 in this example) then the remainder will either be a 0 or 1. If the result is a 0, then router number 0 handles the request. If the result is a 1, then router number 1 handles the request.

Such responses can be used to transfer router information, such as router address information, among other items. The use of such hash type functions can be beneficial in providing a more balanced distribution than other suitable load sharing techniques, in some instances.

With respect to the ability for a network device having redundancy functionality to perform as a redundant device, a network can include a number of network devices in communication with one or more of the first and second routers. In such embodiments, executable instructions can be stored in memory on one or more of the network devices and can be executable on a processor within a network device to send an ARP announcement to a number of the network devices from the second router indicating the first router has failed.

In such instances, the one or more network devices that receive the ARP announcement redirect all traffic, directed to the first router, to the second router. As stated above, the ARP announcement can be used to update router settings (e.g., settings with a route table) within a device that is routing information (e.g., network traffic, such as passing packets between network devices) to the router.

In this way, with updated addressing information, for example, the network device can redirect the information accordingly, thereby avoiding sending the information to the failed routing device. In such failures, a first network device on one side of the router will no longer have connectivity with a number of second devices on the other side of the failed router until the route table of the first network device is updated via the gratuitous ARP response that was sent by the one or both of the RRP devices.

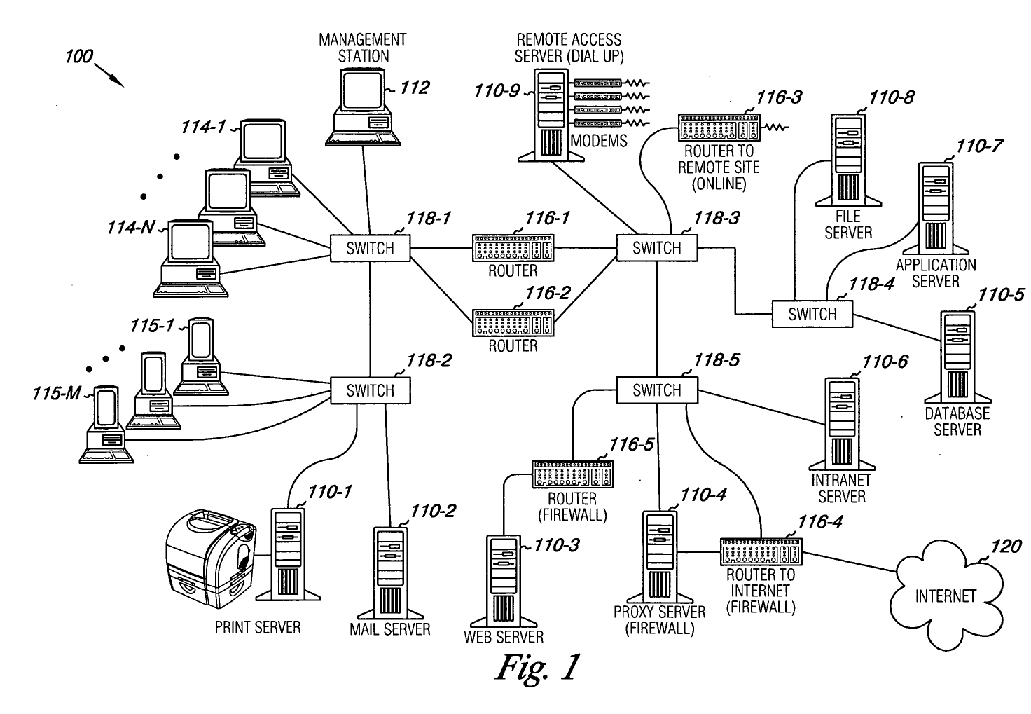

FIG. 1 illustrates a communication network with which various embodiments of the invention can be implemented. As shown in FIG. 1, a number devices can be networked together in a LAN and/or WAN via routers, hubs, switches and the like. As used herein a “network device” means a switch, router, hub, bridge, etc., i.e., a device having processor and memory resources and connected to a network 100, as the same will be understood by one of ordinary skill in the art.

As the reader will appreciate, the term network device can also be used to refer to servers, personal computing devices, etc., as illustrated further below. Although specific embodiments of the invention may be described herein as implemented with a “switch”, those skilled in the art will realize that embodiments may be implemented with other network devices.

FIG. 1 illustrates a number of servers for a number of different types of service on a LAN. However, in some systems several functions can be combined in one device or machine and, for large volumes, multiple devices or machines can be used for the same service. For example, an enterprise system or network can include a collection of servers, or server farm, cooperating to provide services to the network.

Thus, FIG. 1 illustrates a communication network 100 having a number of network devices 110-1 through 118-5. In the illustrated embodiment of FIG. 1, the network includes a print server 110-1 to handle print jobs for the network 100, a mail server 110-2, a web server 110-3, a proxy server (firewall) 110-4, a database server 110-5, and intranet server 110-6, an application server 110-7, a file server 110-8, and a remote access server (dial up) 110-9. The illustrated servers are provided as examples and more or less or different types of servers may be provided in various other embodiments of the invention.

The embodiment of FIG. 1 further illustrates a network management station 112 (e.g., a personal computing (PC) device or workstation) a first number of network client devices 114-1 . . . 114-N, which in the illustrated embodiment in FIG. 1 include, for example, handheld devices, such as personal digital assistants, telephones, and/or the like, and/or PCs, such as laptops, desktops, and servers, among other devices, and a second number of network client devices 115-1 . . . 115-M, which, for example, can include terminals and/or peripherals, such as scanners, facsimile devices, handheld multifunction devices, and/or the like.

The embodiment of FIG. 1, also illustrates that all of these devices can be connected to one another and/or to other networks via network devices having routing functionality (e/g/. routers), 116-1, 116-2, 116-3, 116-4, and 116-5 and/or other network devices including hubs and/or switches 118-1, 118-2, 118-3, 118-4, and 118-5.

The designators “N” and “M” are used to indicate that a number of access points and/or multimedia devices can be attached to the network. The number that N represents can be the same or different from the number represented by M.

As one of ordinary skill in the art will appreciate, many of the network devices (e.g., switches 118-1, 118-2, 118-3, 118-4, 118-5 and/or hubs) can include logic circuitry, such as a processor in communication with memory, and can include network logic chips having a number of network ports. As used herein, a “network chip” includes hardware in the form of logic/circuitry, e.g., transistor gates in an application specific integrated circuit (ASIC), which can execute instructions to perform a particular task.

By way of example and not by way of limitation, the network management station 112 can include logic circuitry and memory. Similarly, network devices such as routers, 116-1, 116-2, 116-3, 116-4, and 116-5 hubs, and/or switches 118-1, 118-2, 118-3, 118-4, and 118-5 may include logic circuitry and memory resources, along with network chips having hardware logic or application specific integrated circuits (ASICs) associated with ports. Embodiments of the various devices in the network are not limited to a number, type or size of logic circuitry or memory resources.

In such embodiments, the switches (e.g., layer-2 switch) are provided within the network to direct information between the client devices (e.g., 114-1) and the routers (e.g., 116-1 and 116-2). Additionally, the communication between routers and/or other equipment in the network can be provided by various network protocols including, but not limited to, Simple Network Management Protocol (SNMP), Common Management Information Protocol (CMIP), and Distributed Management Environment (DME), to name a few.

The routers 116-1 and 116-2 illustrate a redundant router pair where one router (e.g., 116-1) acts as a primary router and the second router (e.g., 116-2) acts as a backup for router 116-1 if router 116-1 becomes inoperable. As such, in various embodiments, the redundant routers 116-1 and 116-2 can also provide load sharing functionality as discussed herein.

Many of these network devices include or are associated with logic circuitry and memory hardware. By way of example and not by way of limitation, the network management station 112 can include logic circuitry and memory. Embodiments of the invention are not limited, to the various exemplary devices illustrated in FIG. 1, or to the number, type, or size of logic circuitry and/or memory resources.

Executable instructions can reside on a network management station to manage and/or monitor a network. Managing and/or monitoring a network can include instructions for the configuration of new and/or existing devices connected to the network.

Executable instructions, as described in more detail herein, can reside on the various network devices. For example, instructions in the form of firmware and/or software can be resident on the network 100 in the memory of a network management station 112 and/or one or more routers, 116-1, 116-2, 116-3, 116-4, and 116-5 hubs, and/or switches 118-1, 118-2, 118-3, 118-4, and 118-5, and can be executable by the processor(s) and/or logic (e.g., hardware in the form of transistor gates) thereon. Also, executable instructions can be resident in a number of locations on various network devices in the network 100 as can be employed in a distributed computing network.

As one of ordinary skill in the art will appreciate, each network device in the network 100 can be physically associated with a port of a switch to which it is connected. Data packets pass through the network.

Users physically connect to the network through these ports. Data frames, or packets, can be transferred between network devices by means of a switch's logic link control (LLC)/ media access control (MAC) circuitry, or “engines”, associated with ports on a network device, e.g., switch.

A network switch forwards data frames received from a transmitting network device to a destination network device based on the header information in received data packets. The switch can also forward packets from a given network to other networks through ports on one or more other switches.

The various devices attached to the network 100 can have their socket connection's IP address and/or port number mapped within the network 100 (e.g., mapped to the network management station and stored in a memory directory or database on the network management station or elsewhere at a known location in a distributed network). An IP address and/or a port number of a socket connection can be mapped within a network, for example, based upon network device connection routines, as devices are connected to the network.

In various embodiments, a router can manage traffic from more than one network. For example, in some embodiments one or more devices can include instructions for assigning a first Internet protocol address for a first local area network and assigning a second Internet protocol address for a second local area network to a router. This allows additional traffic to be provided through a particular router.

In such instances, the redundancy and load sharing features of such devices can also be designed to manage the traffic from the multiple networks. Further, in some embodiments, such as that shown in FIG. 1, a network can be connected to other networks via the Internet or other WAN type connections. Network(s) in communication with, or including the routers, can be of various types including, but not limited to, Local Area Networks (LAN), Wide Area Networks (WAN), Metropolitan Area Networks (MAN), or the like.

Embodiments are of the invention may include a method implemented by instructions provided on a computer readable medium. As used herein, a computer readable medium is intended to include any type of material that a computer is capable of reading information from. Information can include data or instructions that can be executed by logic circuitry on a computing device.

For example, computer readable mediums can include optical or magnetic media, among other types and can include random access memory (RAM), read only memory (ROM), and/or Flash memory. Embodiments as will be described further herein can be included with a computer readable medium and may also be provided using a carrier wave over a communications network such as the Internet, among others.

As the reader will appreciate, various embodiments described herein can be performed by software, application modules, application specific integrated circuit (ASIC) logic, and/or executable instructions operable on the systems and devices shown herein or otherwise. “Software”, as used herein, includes a series of executable instructions that can be stored in memory and executed by the hardware logic of a processor (e.g., transistor gates) to perform a particular task.

Memory, as the reader will appreciate, can include random access memory (RAM), read only memory (ROM), non-volatile memory (such as Flash memory), etc. An “application module” means a self-contained hardware or software component that interacts with a larger system.

As the reader will appreciate a software module may come in the form of a file and handle a specific task within a larger software system. A hardware module may be a separate set of logic, e.g., transistor/circuitry gates, that “plug-in” as a card, appliance, or otherwise, to a larger system/device.

Embodiments of the present invention, however, are not limited to any particular operating environment or to executable instructions written in a particular language or syntax. Software, application modules and/or logic, suitable for carrying out embodiments of the present invention, can be resident in one or more devices or locations or in several devices and/or locations in a network.

Various embodiments may be implemented in a stand-alone computing system or a distributed computing system. A “distributed computing network” means the use of multiple computing devices in a network to execute various roles in executing instructions, e.g., application processing, etc.

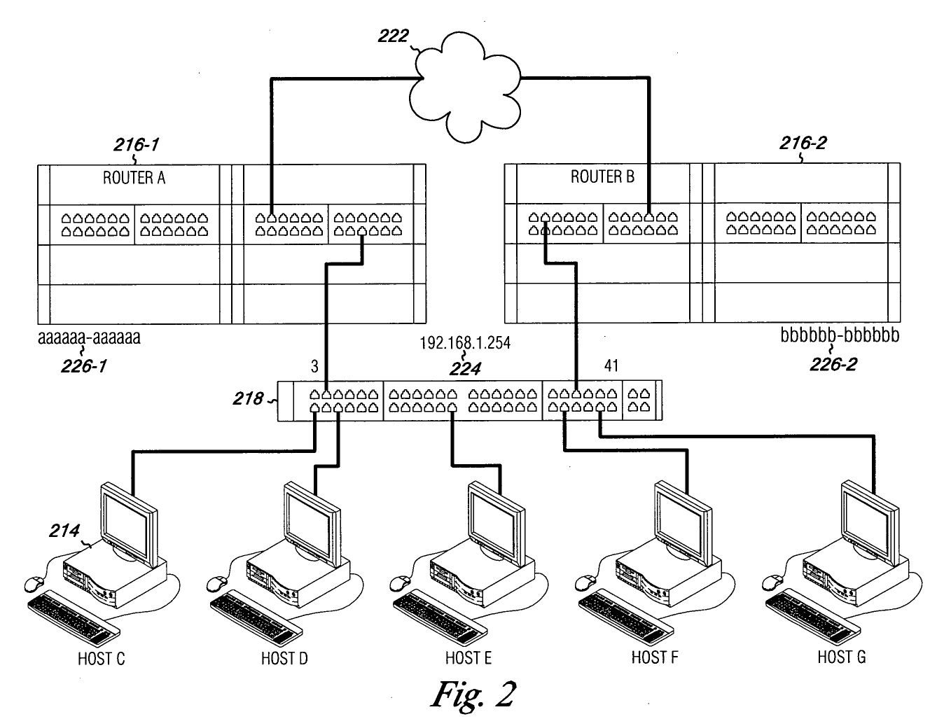

As such, FIGS. 1 and 2 are intended to provide a context for the description of the functions and operations of the various embodiments. That is, the functions and operations described herein may be performed in one or more of the network devices described herein.

Unless explicitly stated, the method embodiments described herein are not constrained to a particular order or sequence. Additionally, some of the described method embodiments can occur or be performed at the same point in time.

In some embodiments, a method can include receiving an ARP request from a computing device, performing a hash function on the ARP request, and sending an ARP response to the computing device, where the ARP response includes router address information.

As discussed above, the hash function can be used as a mechanism to sort out which of a number of network devices with routing functionality should handle a particular packet being received or which device should be ready to receive the next packet, among other routing device decisions. In some embodiments, performing a hash function on the ARP request includes performing a hash function on the ARP request on multiple routers (e.g., first router and a second router).

As discussed above, this hashing function can be the basis for selecting one of the routers. For example, a router can be selected based upon which router number corresponds to a result of a hash function and the sending of an ARP response to the computing device from the selected router can be initiated.

In some embodiments, a modulo hash function can be used. For example, the modulo hash function can be applied to the information within the ARP request packet received. In the example of a system that has to determine which of two routing devices is to receive a packet, the divisor is the number of devices (2) in the modulo function (dividend) mod (divisor). A modulo hash function can provide a nearly 50/50 distribution of packets between two routers, in some embodiments.

FIG. 2 illustrates an example of a router redundancy configuration where the routers are communicating with a several computing devices on the network. In some embodiments, the network device can include executable instructions that execute to provide an operational status signal between the network device having router functionality and one or more other network devices. Such an operational status signal can allow two or more devices providing redundancy and/or other network devices to know whether the network device having routing functionality is available to receive communications.

In various embodiments, this signal can be provided by an ARP announcement (e.g., a gratuitous ARP). An ARP announcement can, for example, be a packet (e.g., an ARP request) containing sender hardware address information and/or sending IP address information for the sending computing device. Such requests typically are not intended to solicit a reply, but merely to update address information (e.g., MAC address information) on the devices of the network.

FIG. 2 illustrates a network having a number of network computing devices 214 connected to a switch 218 and to other network devices via a number of routers 216 (e.g., 216-1 and 216-2). In FIG. 2, the number of other network devices are generally indicated as cloud 222. The structure of FIG. 2 is generally analogous to elements 114-1 . . . 114-N, switch 118-1, routers 116-1 and 116-2, and the various other network components connected to routers 116-1 and 116-2 of FIG. 1. In the embodiment of FIG. 2, routers 216-1 and 216-2 can, for example, be routers 116-1 and 116-2 in the network of FIG. 1.

In some embodiments, different IP addresses are provided to each router to enable data packets to be directed to each router interface. However, in the embodiment shown in FIG. 2, executable instructions can execute to assign the routers 216-1 and 216-2 an IP address 224 (e.g., 192.168.1.254).

This allows all packets to be shared between the router that share the same IP address, since the sender will not know that more than one devices is receiving packets at the address. Also, when one of the routers fails, the redundant router already has the correct IP address, making the transition from the primary router to the secondary router, faster and easier to implement.

As shown in FIG. 2, executable instructions can execute to assign each router a MAC address 226-1 and 226-2. In some embodiments, MAC addresses include twelve digit numbers (e.g., twelve digit hexadecimal or six bytes) that identify each network adapter connected to the router.

In the embodiment illustrated in FIG. 2, MAC address aaaaaa-aaaaaa is shown indicating that a network adapter can be connected and assigned MAC address specific to router A 216-1. The MAC address for router B 216-2 is illustrated as bbbbbb-bbbbbb.

In such embodiments, a network adapter can be plugged into the equipment, such as into the bus of a client device or server in a network, to control the communication of data at the data link level (Open System Interconnect (OSI) layers 1 and 2). A network adapter is also commonly called a “network interface card” (NIC).

In such systems, the first six digits (i.e., three bytes) of the address are an Organizational Unique Identifier (OUI). The OUI is the part of the MAC address that identifies the vendor of a network adapter. Administration of OUIs is provided by the IEEE. Executable instructions can execute to use the MAC address in setting up each router in order to identify which network adapter the particular router is to communicate with or from which network adapter data is to be received.

The router 216-2 can be provided with executable instructions executable such that as far as the equipment in communication with the failed router is concerned, the transfer of router functionality has been transparent, in that the equipment can still communicate through the router 216-1 using the same IP addresses and MAC addresses as before.

In various embodiments, executable instructions within the router 216-1 execute to send out router redundancy protocol signals to the router 216-2 at a signal interval (e.g., 5 seconds). If the router 216-2 does not hear a router redundancy protocol signal within number of signal interval periods, such as three intervals, the router 216-2 can execute instructions to take control of the IP address and the MAC address of the failed router 216-1 or execute instructions to query the failed router 216-1.

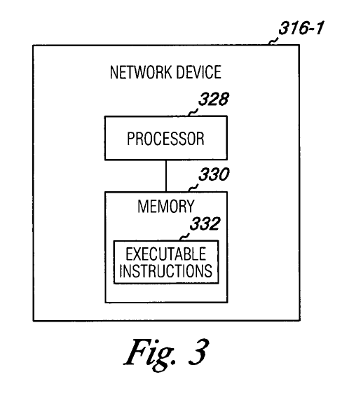

FIG. 3 illustrates a network device embodiment having router redundancy functionality. The device 316-1 illustrated in FIG. 3 can, for example, be router 116-1 or 216-1 in FIGS. 1 and 2. In the network device embodiment of FIG. 3, the device 316-1 includes one or more processors 328 in communication with one or more memory locations 330.

The memory 330 can include a number of executable instructions 332 that can be executed on the processor 328. Memory 330 can also include one or more items of data that can be used in the execution of the instructions 332 by the processor 328. As discussed herein, the instructions can be executable to provide router functionality redundancy for another network device having router functionality. The instructions can also be executable to provide a load sharing functionality between the network devices when both devices are operational, in various embodiments.

In some embodiments, the instructions can be executable to receive an address resolution protocol request from a computing device. Instructions can perform a hash function on the address resolution protocol request and send an address resolution protocol response to the computing device, where the address resolution protocol response includes router address information, in some embodiments. As discussed herein, the use of such hash functionality can aid in the determination of which router of the multiple router redundancy structure is to receive a particular packet from a network device (e.g., network switch 118-1 or 118-3 that are in communication with the redundant routers 116-1 and 116-2 in FIG. 1).

It is to be understood that the above description has been made in an illustrative fashion, and not a restrictive one. Although specific embodiments have been illustrated and described herein, those of ordinary skill in the art will appreciate that other component arrangements and device logic can be substituted for the specific embodiments shown. The claims are intended to cover such adaptations or variations of various embodiments of the disclosure, except to the extent limited by the prior art.

In the foregoing Detailed Description, various features are grouped together in a single embodiment for the purpose of streamlining the disclosure. This method of disclosure is not to be interpreted as reflecting an intention that any claim requires more features than are expressly recited in the claim.

Rather, as the following claims reflect, inventive subject matter lies in less than all features of a single disclosed embodiment. Thus, the following claims are hereby incorporated into the Detailed Description, with each claim standing on its own as a separate embodiment of the invention.

What is claimed:

1. A network device having router functionality, comprising:
a processor;
memory in communication with the processor; and
executable instructions stored in memory and executable on the processor to:
provide router functionality redundancy for another network device having router functionality; and
provide a load sharing functionality between the network devices when both devices are operational.

2. The network device of claim 1, further including executable instructions which execute to provide an operational status signal between the network device and the other network device having router functionality.

3. The network device of claim 1, where the network device is a management station device.

4. The network device of claim 1, where the network device is a network switch device.

5. The network device of claim 1, where the network device is a network server device.

6. The network device of claim 1, further including executable instructions which execute to utilize the same Internet protocol address for the network devices as that of the other network device having router functionality.

7. The network device of claim 1, further including executable instructions which execute to utilize a different media access control address for the network device than that of the other network device having router functionality.

8. A network management system, comprising:
a first router;
a second router including:
a processor;
memory in communication with the processor;
instructions stored in memory and executable on the processor to provide redundancy of a router functionality of the first router; and
means for balancing a load across multiple routers including at least the first router and the second router.

9. The system of claim 8, where means for balancing a load across multiple routers includes executing a hash function on at least two of the multiple routers and selecting a winning router based upon whether an assigned router number corresponds to a result of the executed hash function.

10. The system of claim 8, where means for balancing a load across multiple routers includes sending an address resolution protocol response to a computing device from the selected router once the selection has been made.

11. The system of claim 10, where sending an address resolution protocol response to a computing device from the selected router includes sending an address resolution protocol response including router address information.

12. The system of claim 8, where the system further includes a number of network devices in communication with one or more of the first and second routers and where executable instructions are stored in memory and executable on the processor to send an address resolution protocol announcement to a number of the network devices from the second router indicating the first router has failed.

13. The system of claim 8, where the number of network devices that receive the address resolution protocol announcement redirect all traffic directed to the first router to the second router.

14. A computer readable medium having a program to cause a device to perform a method, comprising:
receiving an address resolution protocol request from a computing device;
performing a hash function on the address resolution protocol request; and
sending an address resolution protocol response to the computing device, where the address resolution protocol response includes router address information.

15. The medium of claim 14, where performing a hash function on the address resolution protocol request includes performing a hash function on the address resolution protocol request on the first router and the second router.

16. The medium of claim 14, where the method further includes selecting one of the first or second routers based upon whether a number assigned to a particular one of the routers corresponds to a result of the executed hash function and initiating the sending of an address resolution protocol response to the computing device from the selected router.

17. The medium of claim 14, performing a hash function on the address resolution protocol request includes performing a modulo hash function.

18. The medium of claim 14, further including assigning a first Internet protocol address for a first local area network and assigning a second Internet protocol address for a second local area network to a first router.

19. The medium of claim 18, where the method includes providing router redundancy for both the first and second local area networks with the second router.

20. The medium of claim 19, where the method includes providing load sharing for both the first and second local area networks with the second router.

21. The medium of claim 18, where the method includes providing load sharing for both the first and second local area networks with the second router.
